(19) United States
(12) Patent Application Publication
(10) Pub. No.: US 2024/0375527 A1
(43) Pub. Date: Nov. 14, 2024

(54) METHOD AND INFORMATION PROCESSING APPARATUS

(71) Applicant: TOYOTA JIDOSHA KABUSHIKI KAISHA, Toyota-shi (JP)

(72) Inventors: Ryosuke KOBAYASHI, Nagakute-shi (JP); Koichi WATANABE, Tokyo-to (JP); Motofumi KAMIYA, Nagoya-shi (JP); Masaki NISHINO, Anjo-shi (JP); Jean-Sebastien BOIRE, Yokohama-shi (JP); Takuya NISHIOKA, Nagoya-shi (JP); Yohei NAKANISHI, Nagoya-shi (JP); Masaki MAKIHARA, Okazaki-shi (JP)

(73) Assignee: TOYOTA JIDOSHA KABUSHIKI KAISHA, Toyota-shi (JP)

(21) Appl. No.: 18/657,780

(22) Filed: May 8, 2024

(30) Foreign Application Priority Data
May 9, 2023 (JP) 2023-077484

(51) Int. Cl. B60L 53/00; B60L 58/13; G06Q 10/02

(52) U.S. Cl. CPC B60L 53/00; B60L 58/13; G06Q 10/02; B60L 2240/622; B60L 2260/54

(57) ABSTRACT

An information processing apparatus acquires information indicating a route for a going and/or return trip of a power supply vehicle to supply power to a first vehicle at a first destination. The information processing apparatus then acquires positional information for and SOCs of a plurality of second vehicles. The information processing apparatus then identifies, from among the plurality of second vehicles, one or more second vehicles that are present in a vicinity of the first destination and/or on the route of the power supply vehicle and whose SOCs are less than a first standard value. The information processing apparatus then proposes to each of the one or more second vehicles identified a reservation for use of a power supply service in which the power supply vehicle supplies power.

### CROSS-REFERENCE TO RELATED APPLICATION

This application claims priority to Japanese Patent Application No. 2023-077484 filed on May 9, 2023, the entire contents of which are incorporated herein by reference.

### TECHNICAL FIELD

The present disclosure relates to a method and an information processing apparatus.

### BACKGROUND

Technology for supplying power by a power supply vehicle when, for example, an electric vehicle runs out of electricity is known. For example, Patent Literature (PTL) 1 discloses technology in which a vehicle that has run out of electricity transmits information including the current position of the vehicle to a server and each of multiple power supply vehicles transmits information including the position of each power supply vehicle to the server, whereby the server selects a power supply vehicle to supply power to the vehicle that has run out of electricity.

### CITATION LIST

### Patent Literature

PTL 1: JP 2019-086841 A

### SUMMARY

There is room for improvement with respect to technology for supplying power by power supply vehicles.

It would be helpful to improve technology for supplying power by power supply vehicles.

A method according to an embodiment of the present disclosure is a method performed by an information processing apparatus, the method including:
acquiring information indicating a route for a going and/or return trip of a power supply vehicle to supply power to a first vehicle at a first destination;
acquiring positional information for and SOCs of a plurality of second vehicles;
identifying, from among the plurality of second vehicles, one or more second vehicles that are present in a vicinity of the first destination and/or on the route of the power supply vehicle and whose SOCs are less than a first standard value; and
proposing to each of the one or more second vehicles identified a reservation for use of a power supply service in which the power supply vehicle supplies power.

An information processing apparatus according to an embodiment of the present disclosure is an information processing apparatus including a controller configured to:
acquire information indicating a route for a going and/or return trip of a power supply vehicle to supply power to a first vehicle at a first destination;
acquire positional information for and SOCs of a plurality of second vehicles;
identify, from among the plurality of second vehicles, one or more second vehicles that are present in a vicinity of the first destination and/or on the route of the power supply vehicle and whose SOCs are less than a first standard value; and
propose to each of the one or more second vehicles identified a reservation for use of a power supply service in which the power supply vehicle supplies power.

According to an embodiment of the present disclosure, technology for supplying power by power supply vehicles is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a vehicle;

FIG. 3 is a block diagram illustrating a schematic configuration of a power supply vehicle;

FIG. 4 is a block diagram illustrating a schematic configuration of an information processing apparatus; and

FIG. 5 is a flowchart illustrating operations of the information processing apparatus.

### DETAILED DESCRIPTION

Hereinafter, an embodiment of the present disclosure will be described.

### (Outline of Embodiment)

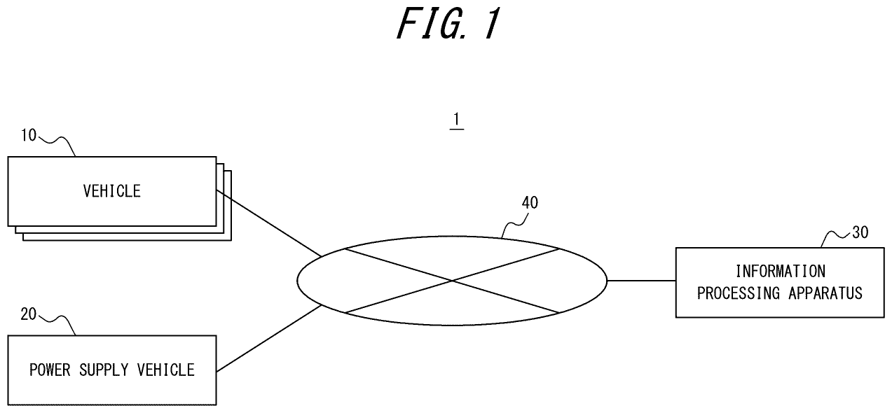

An outline of a system 1 according to an embodiment of the present disclosure will be described with reference to FIG. 1. The system 1 includes a plurality of vehicles 10, a power supply vehicle 20, and an information processing apparatus 30. The plurality of vehicles 10, the power supply vehicle 20, and the information processing apparatus 30 are communicably connected to a network 40 including, for example, the Internet, a mobile communication network, and the like. In the following description, each vehicle 10 in the plurality of vehicles 10 will be referred to as a first vehicle 10A, a second vehicle 10B, and a third vehicle 10C, etc., when distinguishing between them.

The vehicle 10 is an automobile, for example, but is not limited to this and may be any appropriate vehicle. The automobile is, for example, an automobile powered by electric power such as a battery electric vehicle (BEV), a hybrid electric vehicle (HEV), a plug-in hybrid electric vehicle (PHEV), a fuel cell electric vehicle (FCEV), or the like, but is not limited to these. The number of vehicles 10 provided in the system 1 may be freely determined.

The power supply vehicle 20 is a vehicle capable of carrying and moving a battery charged with a large amount of power to power the vehicle 10. The power supply vehicle 20 provides power supply service to the vehicle 10. In FIG. 1, the number of power supply vehicles 20 provided by the system 1 is one, but may be arbitrarily defined. Typically in the provision of power supply service, the power supply vehicle 20 departs from the base, for example, and travels to the location of the user's vehicle, supplies power to the user's vehicle, and then returns to the base. Here, a trip from the base to the location of the user's vehicle is called a going trip, and a trip from the location of the user's vehicle to the base is called a return trip.

The information processing apparatus 30 is, for example, a computer such as a server apparatus. The information processing apparatus 30 can communicate with the plurality of vehicles 10 and the power supply vehicle 20 via the network 40.

First, an outline of the present embodiment will be described, and details thereof will be described later. The information processing apparatus 30 acquires information indicating a route for a going and/or return trip of the power supply vehicle 20 to supply power to the first vehicle 10A at the first destination. The information processing apparatus 30 then acquires positional information for and SOCs (State of Charge) of the plurality of second vehicles 10B. The information processing apparatus 30 then identifies, from among the plurality of second vehicles 10B, one or more second vehicles 10B that are present in the vicinity of the first destination and/or on the route of the power supply vehicle 20 and whose SOCs are less than the first standard value. The information processing apparatus 30 then proposes a reservation for use of the power supply service in which the power supply vehicle 20 supplies power to each of the one or more second vehicles 10B identified.

Thus, according to the present embodiment, the service and energy efficiency of the power supply vehicle 20 can be improved because the power supply vehicle 20 can supply power not only to the first vehicle 10A but also to the one or more second vehicles 10B during a going and/or return trip to supply power to the first vehicle 10A at the first destination. Therefore, according to the present embodiment, the technology for supplying power by the power supply vehicle is improved in that the service and energy efficiency of the power supply vehicle 20 can be improved.

Next, configurations of the system 1 will be described in detail.

### (Configuration of Vehicle)

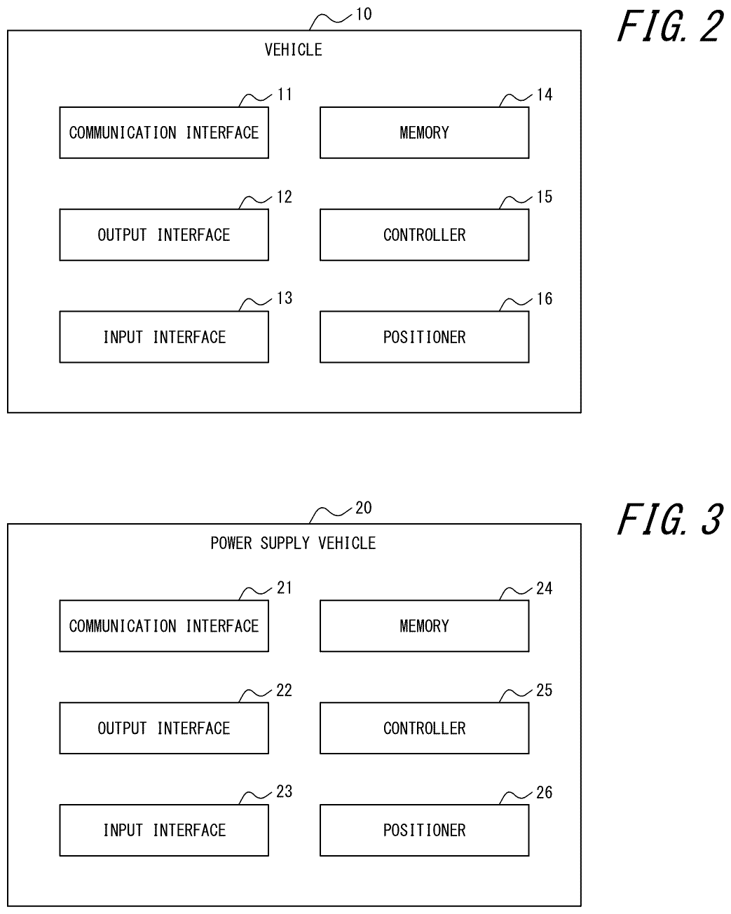

As illustrated in FIG. 2, the vehicle 10 includes a communication interface 11, an output interface 12, an input interface 13, a memory 14, a controller 15, and a positioner 16.

The communication interface 11 includes at least one communication interface for connecting to the network 40. The interface for communication is compliant with mobile communication standards such as the 4th generation (4G) standard or the 5th generation (5G) standard, for example, but these examples are not limiting. In the present embodiment, the vehicle 10 communicates with the information processing apparatus 30 via the communication interface 11 and the network 40.

The output interface 12 includes at least one output device for outputting information. The output device is a display for outputting information as video, a speaker for outputting information as audio, or the like, for example, but is not limited to these. Alternatively, the output interface 12 may include an interface for connecting to an external output device.

The input interface 13 includes at least one input device for detecting an input operation by the user. The input device is a physical key, a capacitive key, a mouse, a touch panel, a touch screen integrally provided with a display of the output interface 12, a microphone, or the like, for example, but is not limited to these. Alternatively, the input interface 13 may include an interface for connecting to an external input device.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information used for operations of the vehicle 10. Any information used for the operations of the vehicle 10 includes SOC. For example, the memory 14 may store a system program, an application program, embedded software, or the like. For example, the information stored in the memory 14 may be updated with, for example, information acquired from the network 40 via the communication interface 11.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire vehicle 10.

The positioner 16 includes one or more apparatuses configured to acquire positional information for the vehicle 10. Specifically, the positioner 16 includes, for example, a receiver compliant with GPS, but is not limited to this example and may include a receiver compliant with any appropriate satellite positioning system.

### (Configuration of Power Supply Vehicle)

As illustrated in FIG. 3, the power supply vehicle 20 includes a communication interface 21, an output interface 22, an input interface 23, a memory 24, a controller 25, and a positioner 26. The communication interface 21, the output interface 22, the input interface 23, the memory 24, the controller 25, and the positioner 26 are similar to the communication interface 11, the output interface 12, the input interface 13, the memory 14, the controller 15, and the positioner 16, respectively, and descriptions thereof are therefore omitted.

### (Configuration of Information Processing Apparatus)

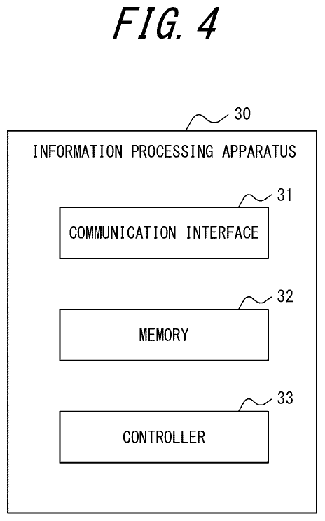

As illustrated in FIG. 4, the information processing apparatus 30 includes a communication interface 31, a memory 32, and a controller 33.

The communication interface 31 includes at least one communication interface for connecting to the network 40. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 30 communicates with the plurality of vehicles 10 and the power supply vehicle 20 via the communication interface 31 and the network 40.

The memory 32 includes one or more memories. The memories included in the memory 32 may each function as, for example, a main memory, an auxiliary memory, or a cache memory. The memory 32 stores any information to be used for the operations of the information processing apparatus 30. For example, the memory 32 may store a system program, an application program, embedded software, a database, and the like. The information stored in the memory 32 may be updated with, for example, information acquired from the network 40 via the communication interface 31.

The controller 33 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 33 controls the operations of the entire information processing apparatus 30.

### (Flow of Operations of Information Processing Apparatus)

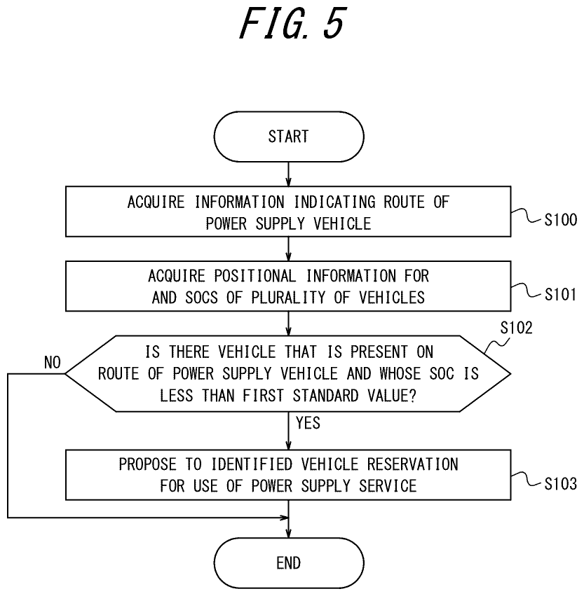

Operations of the information processing apparatus 30 according to the present embodiment will be described with reference to FIG. 5.

S100: The controller 33 of the information processing apparatus 30 acquires information indicating a route for a going and/or return trip of the power supply vehicle 20 to supply power to the first vehicle 10A at the first destination.

Specifically, the controller 33 receives positional information for the first destination, which is the destination of the first vehicle 10A, from the first vehicle 10A via the communication interface 31 and the network 40. The controller 33 calculates a route for a going and/or return trip of the power supply vehicle 20 by, for example, route search, based on the positional information for the first destination, the positional information for the base of the power supply vehicle 20 stored in the memory 32 of the information processing apparatus 30, and the map information stored in the memory 32, thereby acquiring information indicating a route for a going and/or return trip of the power supply vehicle 20 to supply power to the first vehicle 10A.

The “positional information” may include any information indicating location, such as address, latitude and longitude, or facility name.

S101: The controller 33 acquires the positional information for and SOCs of the plurality of second vehicles 10B.

Specifically, the controller 33 receives the positional information for and SOCs of the plurality of second vehicles 10B from the plurality of second vehicles 10B, respectively, via the communication interface 31 and the network 40. For example, the plurality of second vehicles 10B can use their respective positioners 16 to acquire positional information for their respective current positions.

S102: The controller 33 identifies, from among the plurality of second vehicles 10B, one or more second vehicles 10B that are present in the vicinity of the first destination and/or on the route of the power supply vehicle 20 and whose SOCs are less than the first standard value.

Specifically, the controller 33 identifies one or more second vehicles 10B that are present within a predetermined distance from the first destination and/or within a predetermined distance from the route of the power supply vehicle 20 and whose SOCs are less than the first standard value based on the information indicating the route for the going and/or return trip of the power supply vehicle 20 to supply power to the first vehicle 10A acquired in S100, positional information for and SOCs of the plurality of second vehicles 10B acquired in S101, and map information stored in the memory 32, The predetermined distance may be changeable. The first standard value is a predetermined value of SOC, for example, but may be changeable by the operator, for example.

S103: The controller 33 proposes a reservation for use of the power supply service in which the power supply vehicle 20 supplies power to each of the one or more second vehicles 10B identified in S102.

Any method can be employed to propose the reservation for use of the power supply service. For example, the controller 33 may propose to each of the one or more second vehicles 10B identified by transmitting a message via the communication interface 31 proposing a reservation for use of the power supply service. Alternatively, the controller 33 may send instructions via the communication interface 31 to each of the one or more second vehicles 10B identified to output information regarding the proposed reservation for use of the power supply service. Upon receipt of said instructions, the one or more second vehicles 10B will output information via output devices such as displays or speakers, for example, each of them.

For example, if the number of one or more second vehicles 10B identified in S102 is two or more, the controller 33 may propose preferentially to the vehicle 10B with a less SOC among the one or more second vehicle 10B identified reservations for use of the power supply service.

Here, the user of one or more second vehicles 10B who has been proposed to make a reservation for use of the power supply service performs a predetermined user operation to the input interface 13 of the second vehicle 10B if he/she wishes to make a reservation for use of the power supply service. When the controller 15 of the second vehicle B detects the user operation, it transmits information regarding the reservation for use of the power supply service to the information processing apparatus 30 via the communication interface 11. The controller 33 of the information processing apparatus 30 receives the information via, for example, the communication interface 31 and the network 40, modifies the operation plan information of the power supply vehicle 20 stored in the memory 32, and transmits the modified operation plan information to the power supply vehicle 20, thereby accepting the reservation for use of the power supply service. Any method, not limited to this example, can be used to accept reservations for use.

As described above, the information processing apparatus 30 acquires information indicating a route for a going and/or return trip of the power supply vehicle 20 to supply power to the first vehicle 10A at the first destination. The information processing apparatus 30 then acquires the positional information for and SOCs of the plurality of second vehicles 10B. The information processing apparatus 30 then identifies, from among the plurality of second vehicles 10B, one or more second vehicles 10B that are present in the vicinity of the first destination and/or on the route of the power supply vehicle 20 and whose SOCs are less than the first standard value. The information processing apparatus 30 then proposes a reservation for use of the power supply service in which the power supply vehicle 20 supplies power to each of the one or more second vehicles 10B identified.

According to such a configuration, the service and energy efficiency of the power supply vehicle 20 can be improved because the power supply vehicle 20 can supply power not only to the first vehicle 10A but also to the one or more second vehicles 10B during the going and/or return trip to supply power to the first vehicle 10A at the first destination. Therefore, according to the present embodiment, the technology for supplying power by the power supply vehicle is improved in that the service and energy efficiency of the power supply vehicle 20 can be improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 30 in the above embodiment are distributed to multiple computers capable of communicating with each other can be implemented. For example, an embodiment in which some or all of the components of the information processing apparatus 30 are provided in the vehicle 10 or the power supply vehicle 20 can also be implemented. For example, the vehicle 10 may be equipped with some or all of the components of the information processing apparatus 30, and the power supply vehicle 20 may be equipped with some or all of the components of the information processing apparatus 30.

For example, in the embodiment described above, if the controller 33 receives a reservation for use of the power supply service from at least one of the one or more second vehicles 10B, the controller 33 may calculate an SOC prediction of the power supply vehicle 20 after the power supply vehicle 20 has supplied power to the first vehicle 10A and the at least one second vehicle 10B. The controller 33 may then acquire the positional information for and SOCs of the plurality of third vehicles 10C if the calculated SOC prediction of the power supply vehicle 20 is equal to or greater than a predetermined value. The controller 33 may then identify one or more third vehicles 30C that are in the vicinity of the first destination and/or on the route of the power supply vehicle 20 and whose SOCs are equal to or greater than the first standard value and less than the second standard value, and propose to each of the one or more third vehicles 10C identified a reservation for use of the power supply service. The predetermined value for the SOC prediction of the power supply vehicle 20 may be changeable.

The second standard value is a predetermined SOC value and is greater than the first standard value. The second standard value may, for example, be changed by the operator to any value greater than the first standard value.

For example, in the embodiment described above, the controller 33 may monitor the current position of the power supply vehicle 20 while traveling to the first destination. Next, when a change in the route of the power supply vehicle 20 has occurred, the controller 33 may newly identify, from among the plurality of second vehicles 10B, one or more second vehicles 10B that are present on the changed route and whose SOCs are less than the first standard value. Then, a reservation for use of the power supply service may be proposed to each of the one or more second vehicles 10B newly identified.

Any method, such as using GPS, can be employed to monitor the current position of the power supply vehicle 20.

In the embodiment described above, the first base from which the power supply vehicle 20 departs and the second base from which the power supply vehicle 20 returns may be different. In this case, the controller 33 may calculate a route for a going and/or return trip of the power supply vehicle 20 by route search, for example, from the positional information for the first destination, the positional information for the first base stored in the memory 32, the positional information for the second base stored in the memory 32 and the map information stored in the memory 32.

In the embodiment described above, the first destination was the destination of the first vehicle 10A. However, this is not limited to this, for example, if the first vehicle 10A is already parked, the parking position may be used as the first destination.

For example, an embodiment in which a general purpose computer functions as the information processing apparatus 30 according to the above embodiment can also be implemented. Specifically, a program in which processes for realizing the functions of the information processing apparatus 30 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A method performed by an information processing apparatus, the method comprising:
acquiring information indicating a route for a going and/or return trip of a power supply vehicle to supply power to a first vehicle at a first destination;
acquiring positional information for and SOCs of a plurality of second vehicles;
identifying, from among the plurality of second vehicles, one or more second vehicles that are present in a vicinity of the first destination and/or on the route of the power supply vehicle and whose SOCs are less than a first standard value; and
proposing to each of the one or more second vehicles identified a reservation for use of a power supply service in which the power supply vehicle supplies power.

2. The method according to claim 1, further comprising proposing preferentially to a vehicle with a less SOC the reservation for use of the power supply service in a case in which a number of the one or more second vehicles identified is two or more.

3. The method according to claim 1, further comprising:
accepting the reservation for use of the power supply service from at least one second vehicle among the one or more second vehicles;
calculating an SOC prediction of the power supply vehicle after the power supply vehicle has supplied power to the first vehicle and the at least one second vehicle;
acquiring positional information for and SOCs of a plurality of third vehicles in a case in which the calculated SOC prediction is equal to or greater than a predetermined value;
identifying one or more third vehicles that are present in the vicinity of the first destination and/or on the route of the power supply vehicle and whose SOCs are equal to or greater than the first standard value and are less than a second standard value; and
proposing to each of the one or more third vehicles identified the reservation for use of the power supply service.

4. The method according to claim 1, further comprising:
monitoring a current position of the power supply vehicle while traveling to the first destination;
newly identifying, from among the plurality of second vehicles, one or more second vehicles that are present on a changed route and whose SOCs are less than the first standard value in a case in which a change of the route of the power supply vehicle has occurred; and
proposing to each of the one or more second vehicles newly identified the reservation for use of the power supply service.

5. An information processing apparatus comprising a controller configured to:
acquire information indicating a route for a going and/or return trip of a power supply vehicle to supply power to a first vehicle at a first destination;
acquire positional information for and SOCs of a plurality of second vehicles;
identify, from among the plurality of second vehicles, one or more second vehicles that are present in a vicinity of the first destination and/or on the route of the power supply vehicle and whose SOCs are less than a first standard value; and
propose to each of the one or more second vehicles identified a reservation for use of a power supply service in which the power supply vehicle supplies power.
